(19) United States
(12) Patent Application Publication
(10) Pub. No.: US 2009/0032358 A1
(43) Pub. Date: Feb. 5, 2009

(54) Torque Transfer Device Having Reduced Torque Variation

(76) Inventors: Gerhard Bellinger, Muhlhausen (DE); Jorg Molz, Bensheim (DE); Sven Pinzl, Tambach-Dietharz (DE)

Correspondence Address: BorgWarner/BHGL, 524 South Main Street, Suite 200, Ann Arbor, MI, 48104, US

(21) Appl. No.: 12/179,120

(22) Filed: Jul. 24, 2008

Related U.S. Application Data
(60) Provisional application No. 60/953,237, filed on Aug. 1, 2007.

(51) Int. Cl. F16D 27/00

(52) U.S. Cl. 192/84.9

(57) ABSTRACT

An electrically actuated torque transfer device including an input shaft and at least one output shaft selectively coupled to the input shaft. At least one modulating clutch assembly selectively couples the input shaft to the output shaft. The modulating clutch assembly includes an electrical clutch operator configured to engage a ball ramp operator. The ball ramp operator includes first and second opposed annular rings having complimentarily configured opposed ramped recesses and rolling members disposed in the recesses. Relative rotation of the annular rings translates the annular rings axially to engage the clutch assembly and transfer torque from the input shaft to the output shaft. The first annular ring is coupled to the input shaft and the second annular ring is coupled to the output shaft. A third element disposed between the first annular ring and a shoulder of the input shaft has an engagement diameter selected to minimize torque variations between the torque transfer devices.

### CROSS REFERENCE TO RELATED APPLICATION

This application claims the benefit of U.S. provisional application No. 60/953,237, filed Aug. 1, 2007.

### BACKGROUND OF THE INVENTION

1. Field of the Invention

The present invention generally relates to torque transfer devices. More specifically, the invention relates to electrically actuated clutches for mechanical power transmission systems especially useful in motor vehicle powertrains.

2. Description of Related Art

Torque transfer devices, of the electrically actuated clutch type, proportionally transfer torque from an input shaft to an output shaft upon the application of current to an electrical actuator. Each configuration requires the application of a certain amount of current to the electrical actuator to cause the clutch to transfer a given value of torque. Due to manufacturing and component variations between units of a given design, the actual relationship of current to torque will vary. This results in inconsistencies when engaging the torque transfer device. As result, too much or too little torque may be transferred causing, for example, hard or soft engagement of a secondary axle.

In view of the above, there exists a need to reduce torque variation and provide more consistent engagement of electrically actuated torque transfer devices in motor vehicle application.

### SUMMARY OF THE INVENTION

In satisfying the above need, as well as overcoming the enumerated drawbacks and other limitations of the related art, the present invention provides an electrically actuated torque transfer device for use in a motor vehicle. The torque transfer device includes an input shaft and at least one coaxially disposed output shaft. At least one modulating clutch assembly selectively couples the input shaft to the output shaft. The modulating clutch assembly includes an electrical clutch operator configured to engage a ball ramp operator to transfer torque from the input shaft to the at least one output shaft. The ball ramp operator has first and second opposed annular rings with complimentarily configured opposed ramped recesses and rolling members disposed in the recesses such that relative rotation of the annular rings results in relative axial translation between the annular rings (“cams”). The first annular ring (“base cam”) is selectively coupled to the input shaft through a primary clutch. The second annular ring (“apply cam”) is coupled to the output shaft. A third element is coaxially disposed between an axial face of the first annular ring and an axial shoulder of the input shaft is attached to the input shaft and frictionally engages the axial face of the first annular ring when a thrust force is generated.

In one embodiment, the third element has an axial surface with an engagement diameter selected to match the torque capabilities of the device in order to reduce torque variation. In one example, the engagement diameter is defined by in inner and outer diameters of the third element. In another example, the engagement diameter is defined by a chamfer. In yet another example, the engagement diameter is defined by a step diameter of a circumferential lip provided in the axial surface of the third element.

The modulating clutch assembly includes a primary clutch having input and output interleaved clutch plates. The input clutch plates are coupled to the input shaft and the output clutch plates are coupled to the first annular ring. The electrical clutch operator engages the primary clutch to engage the first annular ring with the input shaft to cause relative rotation between the annular rings to generate an axial compression force to axially compress a secondary clutch of interleaved clutch plates and frictionally transfer torque from the input shaft to the output shaft. The secondary clutch includes a set of first and second interleaved clutch plates. The first clutch plates are coupled to the input shaft and the second clutch plates are coupled to the output shaft.

The present invention also includes a method of assembling any of the electrically actuated torque transfer devices described herein. The method includes assembling a subassembly of the torque transfer device and characterizing a torque characteristic of the subassembly. The method also includes selecting a third element having an axial surface with an engagement diameter selected to match the desired torque characteristic of the subassembly, and installing the selected third element between an axial face of the first annular ring and an axial shoulder of the input shaft.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is an example of a schematic of a motor vehicle incorporating a torque transfer device according to the present invention

FIG. 2 is a sectional view of the torque transfer device according to the present invention;

FIG. 3 is front view of a third element of the torque transfer device of FIG. 2;

FIGS. 4A-4D show detail views of a portion of the torque transfer device of FIG. 2; and

FIG. 5 provides a step diagram of one method of assembling a torque transfer device in accordance with this invention.

### DETAILED DESCRIPTION

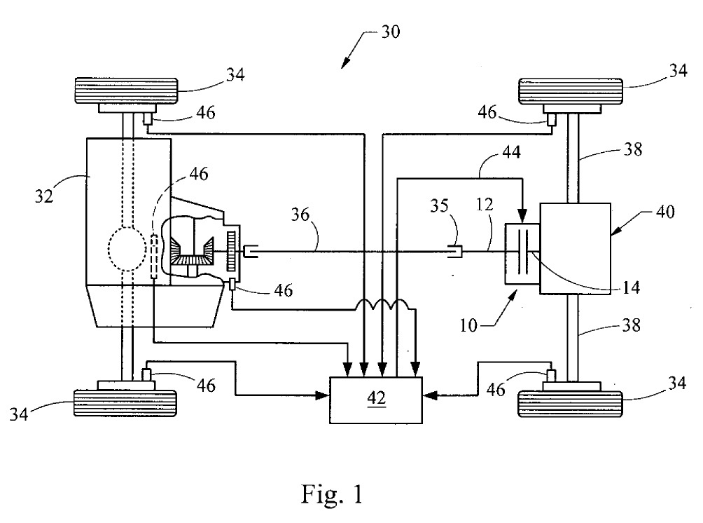

Referring now to the schematic of FIG. 1, an electrically actuated torque transfer device 10 according to the present invention is shown incorporated into a motor vehicle 30. The motor vehicle 30 includes a motive source 32 such as an internal combustion engine or electric motor. A plurality of wheels 34 are coupled to the motive source 32 through a drive member 36 and output members 38. Two output members 38 are shown coupled to the drive member 36 using any embodiment of the torque transfer device 10. In this example, a differential 40 couples the two output members 38 to the output shaft 14 of the device 10.

An electronic control unit (ECU) 42 is attached to the electrical clutch operator of the device 10 through, for example, a cable 44. The PCU 42 is configured to provide a range of electrical currents to the electrical clutch operator based on a desired amount of torque to be transferred from the drive member 36 to the output members 38. The desired amount of torque may be determined by the PCU 42 by reading a plurality of sensors 46 providing information regarding the operational state of the motor vehicle 30.

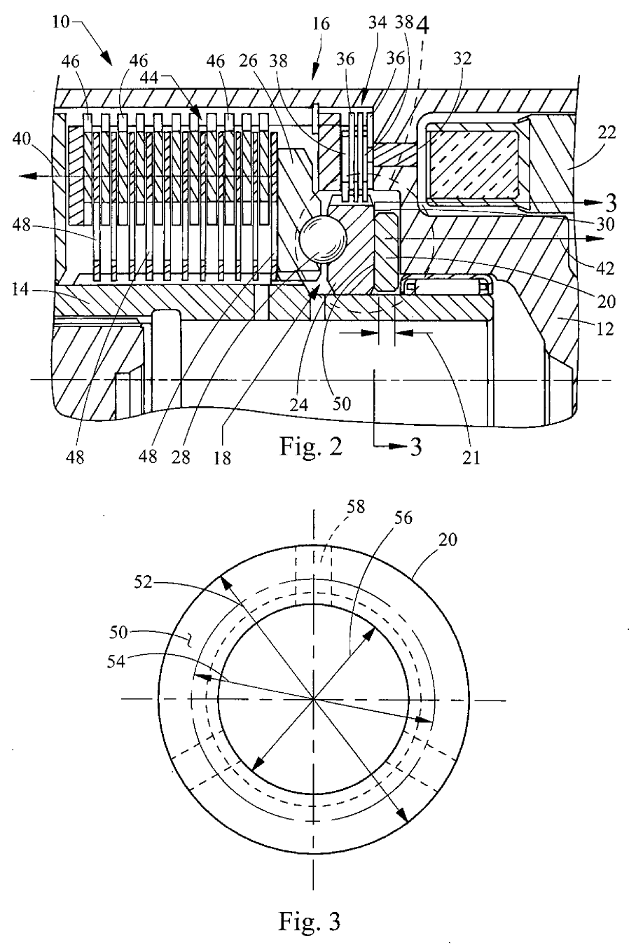

Referring now to FIG. 2, a partial section view of the electrically actuated torque transfer device 10 of the present invention is illustrated in more detail. As its primary components, the device 10 includes an input shaft 12 selectively coupled to a coaxially disposed output shaft 14 by a modulating clutch assembly 16 having a ball ramp operator 18. One example of a torque transfer device having one or more modulating clutch assemblies and including a ball ramp operator is disclosed in U.S. Pat. No. 6,905,008 to Kowalsky which is herein incorporated by reference. Another example is disclosed in U.S. Pat. No. 5,839,328 to Showalter which is also herein incorporated by reference.

The modulating clutch assembly 16 selectively transfers torque from the input shaft 12 to the output shaft 14 by activating an electrical clutch operator 22 of the modulating clutch assembly 16. The electrical clutch operator 22 engages the ball ramp operator 18 to transfer torque between the shafts 12 and 14 through primary and secondary clutches 34 and 44. The ball ramp operator 18 has first and second opposed annular rings 24 and 26 with complimentary, opposed and ramped recesses. Rolling members 28 are disposed within the recesses such that relative rotation of the annular rings 24 and 26 results in relative axial translation. As shown, the first annular ring 24 is selectively coupled to the input shaft 12 by the primary clutch 34. The second annular ring 26 is coupled to the output shaft 14 and is configured to actuate the secondary clutch 44. A third element 20 having an axial thickness 21 is coaxially disposed between an axial face 30 of the first annular ring 24 and an axial shoulder 32 of the input shaft 12. Optionally, the third element 20 is attached to the input shaft 12 and it engages the axial face 30 the first annular ring 24 upon relative axial translation of the annular rings 24 and 26. This basic arrangement including the third element is described by U.S. Pat. No. 6,837,351 which is hereby incorporated by reference.

In the example shown, actuating the electrical clutch operator 22 engages the first annular ring 24, preferably by means of the primary clutch 34, with the input shaft 12 resulting in relative rotation of the annular rings 24 and 26. The resulting axial translation of the second annular ring 26 generates an axial compression force indicated by the arrow 40 compressing a secondary clutch 44 having a set of first and second interleaved clutch plates 46 and 48 to frictionally transfer torque from the input shaft 12 to the output shaft 14 or vice versa. An axial or thrust reaction force indicated by the arrow 42 is generated opposing the axial compression force 40. The axial reaction force 42 acts against the axial shoulder 32 of the input shaft 12 through the first annular ring 24 and the third element 20. The first clutch plates 46 are coupled to the input shaft 12 and the second clutch plates 48 are coupled to the output shaft 14. The clutch plates 46 and 48 are coupled to their respective shafts 14 and 16 by, for example, a complimentary splines or similar features capable of allowing axial movement while transferring radial motion (i.e. torque). The reaction force 42 generates a rotational friction torque based on the coefficient of friction and the effective diameters of the faces of ring 24 and third element 20 which confront one another.

The electrical clutch operator 22 engages the first annular ring 24 with the input shaft 12 through the primary clutch 34 having input and output interleaved clutch plates 36 and 38. The input clutch plates 36 are coupled to the input shaft 12 and the output clutch plates 38 are coupled to the first annular ring 24 similar to the first and second clutch plates 46 and 48. The electrical clutch operator 22 includes, but is not limited to, an electromagnetic coil configured to magnetically compress the interleaved clutch plates 36 and 38 to frictionally engage the first annular ring 24 with the input shaft 12 to cause the above mentioned relative rotation between the first and annular rings 24 and 26.

Other instances of the electrical clutch operator 22 may have any other appropriate device for engaging the first annular ring 24 with the input shaft 12. In addition to the electromagnetic example described above, other examples include, but are not limited to, electromechanical devices and electrohydraulic devices. The electromechanical device may include any appropriate electric motor configured to mechanically compress the interleaved clutch plates 36 and 38. The electrohydraulic device may include an electric pump and/or an electrically actuated valve to hydraulically compress the interleaved clutch plates 36 and 38.

Due to normal manufacturing variations between production units of the torque transfer devices 10, the torque transfer capabilities of each unit will vary with certain product characteristics. Selection of an engagement diameter 54 of the third element 20 is a way of tailoring the torque characteristics of each unit. To provide a desired torque characteristic, an appropriate third element 20 is selected to match the torque characteristics with the envisaged target torque of the device 10.

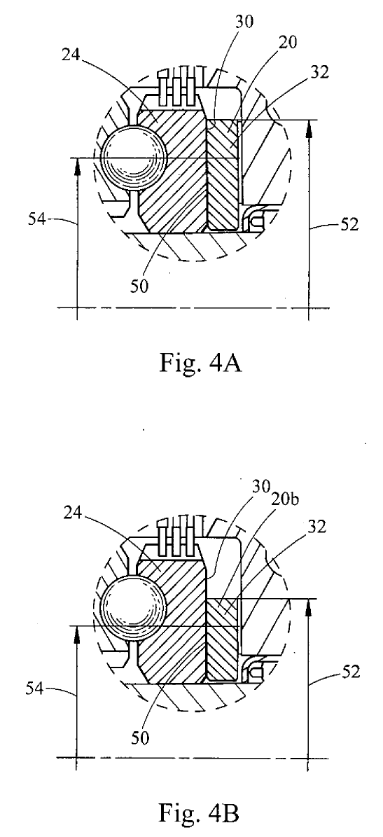

Turning now to FIG. 3, a front view of the third element 20 is shown in more detail. The third element 20 has an axial surface 50 with an outer diameter 52. The engagement diameter 54 is defined as an intermediate diameter between the outer diameter 52 and an inner diameter 56. The engagement diameter 54 is a diameter which, when considered with the coefficient of friction between the confronting surfaces and the normal (thrust) applied force, characterizes the frictional torque characteristics at the interface of third element 20 and ring 24. The engagement diameter may be close to the radial midpoint between diameters 52 and 56 or slightly larger than the midpoint. Engagement diameter 54 is affected by both diameters 52 and 56. One or more projections 58 (shown as hidden lines) opposite the axial surface 50 may be provided to engage complimentary recesses (not shown) in the axial shoulder 32 of the input shaft 12 such that the third element 20 is attached to and rotates with the input shaft 12 to prevent relative rotation therebetween.

The dimensions of the third element 20 depends on the needs of each particular application. In one non-limiting example, the engagement diameter 52 may be in the range of about fifty-four to fifty-eight millimeters. Preferably, the third element 20 is made of any low friction, low wear compound. Some non-limiting examples of such a compound include polyamide-imide resins and fluropolymer resins such as polytetrafluoroethylene (PTFE).

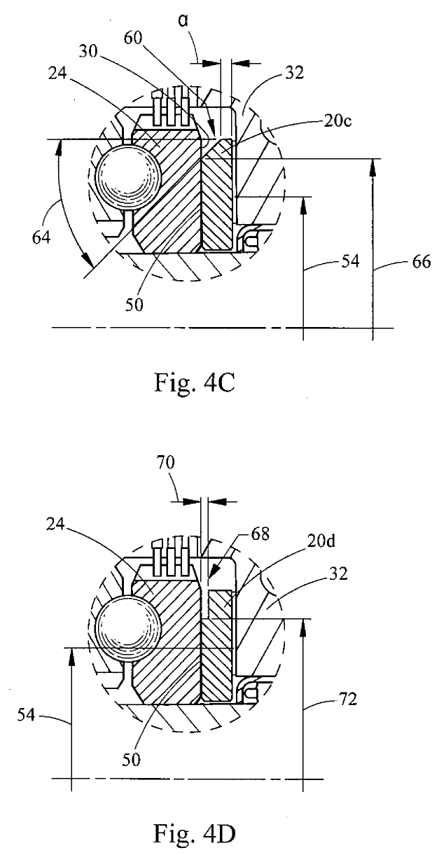

Turning now to FIGS. 4A-4D, various examples of the third element 20 are shown in a partial section along with the first annular ring 24 and the axial shoulder 32 of the input shaft 12. FIG. 4A shows the third element 20 of FIG. 2 where the engagement diameter 54 is adjusted based upon the outer diameter 52 being selected such that almost the entire axial face 30 of the first annular ring 24 engages the axial surface 50. FIG. 4B shows a third element 20b having a reduced outer diameter 52 such that only a portion of the axial face 30 is engaged by the axial surface 50. FIGS. 4C and 4D achieves a similar effect by providing a chamfer 60 in FIG. 4C and a circumferential lip 68 in FIG. 4D also adjusts outer diameter 52 resulting in only a portion of the axial face 30 engaging the axial surface 50. The chamfer 60 is defined by a chamfer angle 64 and a chamfer diameter 66 and the circumferential lip 68 is defined by a notch depth 70 and a step diameter 72.

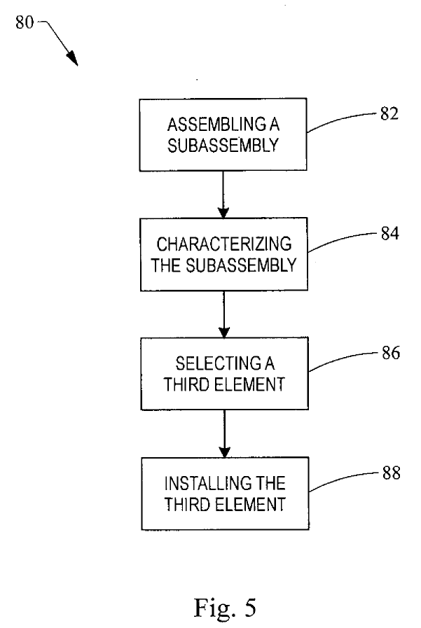

Turning now to FIG. 5, one example of a method of assembling any of the torque transfer devices described herein is described and designated at 80. The method includes assembling a subassembly of the torque transfer device at box 82 and characterizing the torque capability of the subassembly at box 84. Box 86 provides for selecting a third element having an axial surface with an engagement diameter selected to match the torque capability of the subassembly and box 88 installs the selected third element between an axial face of the first annular ring and an axial shoulder of the input shaft.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

We claim:

1. An electrically actuated torque transfer device for use in a motor vehicle, the torque transfer device comprising:
an input shaft and at least one output shaft selectively coupled to the input shaft;
at least one modulating clutch assembly selectively coupling the input shaft to the output shaft, the modulating clutch assembly including an electrical clutch operator configured to engage a ball ramp operator;
the ball ramp operator including first and second opposed annular rings having complimentarily configured opposed and ramped recesses with rolling members disposed in the recesses such that relative rotation of the first and second annular rings causes relative axial translation of the first and second annular rings, the first annular ring being coupled to the input shaft and the second annular ring being coupled to the output shaft; and
a third element defining an axial thickness and an axial surface having an engagement diameter being coaxially disposed between the first annular ring and the input shaft, the axial surface of the third element frictionally engaging the axial face of the first annular ring upon the relative axial translation of the annular rings, and the engagement diameter being selected to provide desired torque transfer characteristics for the torque transfer device.

2. The torque transfer device of claim 1, wherein the third element is disposed between an axial face of the first annular ring and an axial shoulder of the input shaft.

3. The torque transfer device of claim 1, wherein the third element is attached to and rotates with the input shaft.

4. The method of claim 1, wherein the axial surface of the third element engages only a portion of the axial face of the first annular ring.

5. The torque transfer device of claim 1, wherein the engagement diameter is in a range which is determined for every individual application of the torque transfer device.

6. The torque transfer device of claim 1, wherein the engagement diameter is adjusted by variations in the outer diameter of the third element.

7. The torque transfer device of claim 1, wherein the engagement diameter is adjusted by variations in the chamfer inner diameter of a chamfer provided at an intersection of the axial surface and an outer diameter of the third element.

8. The torque transfer device of claim 1 wherein the engagement diameter is adjusted by variations in a step diameter of a circumferential lip provided in the axial surface of the third element.

9. The torque transfer device of claim 1, wherein the modulating clutch assembly further includes a primary clutch having a set of input and output interleaved clutch plates, the input clutch plates being coupled to the input shaft and the output clutch plates being coupled to the first annular ring, the electrical clutch operator engaging the primary clutch to cause relative rotation between the annular rings to generate an axial compression force to axially compress a secondary clutch including a set of interleaved clutch plates to frictionally transfer torque from the input shaft to the output shaft.

10. The torque transfer device of claim 9, wherein an axial reaction force is generated opposite the axial compression force, the axial reaction force acting against the axial shoulder of the input shaft through the first annular ring and the third element.

11. A method of assembling an electrically actuated torque transfer device for use in a motor vehicle, the method comprising:
assembling a subassembly of the torque transfer device, the subassembly including an input shaft and at least one output shaft selectively coupled to the input shaft, at least one modulating clutch assembly selectively coupling the input shaft to the output shaft, the modulating clutch assembly including an electrical clutch operator configured to engage a ball ramp operator, the ball ramp operator including first and second opposed annular rings having complimentarily configured opposed and ramped recesses with rolling members disposed in the recesses such that relative rotation of the annular rings causes relative axial translation of the annular rings, the first annular ring being selectively coupled to the input shaft by a primary clutch and the second annular ring being coupled to the output shaft and engaging a secondary clutch;
characterizing a torque characteristic of the subassembly;
selecting a third element having an axial surface with an engagement diameter selected to provide a desired torque transfer characteristic of the subassembly; and
installing the selected third element between the first annular ring and the input shaft.

12. The method of claim 11, wherein the third element of the installing step is attached to an axial shoulder of the input shaft and frictionally engages an axial face of the first annular ring.

13. The method of claim 12, wherein the axial surface of the third element of the installing step engages only a portion of the axial face of the first annular ring.

14. The method of claim 11, wherein the engagement diameter of the third element of the selecting step is in a range which is determined for every individual application of the torque transfer device.

15. The method of claim 11, wherein the engagement diameter of the third element of the selecting step is defined by adjusting an outer diameter of the third element.

16. The method of claim 11, wherein the engagement diameter of the third element of the selecting step is defined by a chamfer diameter of a chamfer provided at an intersection of the axial surface and an outer diameter of the third element.

17. The method of claim 11, wherein the engagement diameter of the third element of the selecting step is defined by a step diameter of a circumferential lip provided in the axial surface of the third element.
